(19) United States
(12) Patent Application Publication
(10) Pub. No.: US 2025/0074003 A1
(43) Pub. Date: Mar. 6, 2025

(54) SCANNER CALIBRATION FOR ADDITIVE MANUFACTURING

(71) Applicant: nLIGHT, Inc., Camas, WA (US)

(72) Inventors: Aaron Brown, Vancouver, WA (US); Scott R. KARLSEN, Battle Ground, WA (US); Bodo SCHMIDT, Carlsbad, CA (US); Robert J. Martinsen, West Linn, OR (US)

(21) Appl. No.: 18/807,712

(22) Filed: Aug. 16, 2024

Related U.S. Application Data
(60) Provisional application No. 63/621,958, filed on Jan. 17, 2024.
(60) Provisional application No. 63/535,267, filed on Aug. 29, 2023.

(51) Int. Cl. B29C 64/393; B29C 64/214; B29C 64/268; B33Y 30/00; B33Y 50/02

(52) U.S. Cl. CPC B29C 64/393; B29C 64/214; B29C 64/268; B33Y 30/00; B33Y 50/02

(57) ABSTRACT

A 3D printer includes a print bed adapted to receive a layer of print medium, a recoater adapted to distribute the print medium onto the print bed, a laser source adapted to generate a non-interactive laser beam and an interactive laser beam, a controller connected to the laser source to direct the interactive laser beam to the at least one predetermined location, a plurality of fiducial features associated with the recoater, wherein the plurality of fiducial features are presented by the recoater while the recoater distributes the print medium on the print bed to form a layer, and a scanner connected to the controller to detect, via the non-interactive laser beam, the plurality of fiducial features and provide location information for locations of individual ones of the plurality of fiducial features. The controller performs a calibration to adjust where the interactive laser beam is directed to the print medium.

### CROSS-REFERENCE TO RELATED APPLICATION(S)

This United States Non-Provisional Patent Application relies on and claims priority to U.S. Provisional Patent Application Ser. No. 63/535,267, filed on Aug. 29, 2023, and on U.S. Provisional Patent Application Ser. No. 63/621,958, filed on Jan. 17, 2024, the entire contents of both of which are incorporated herein by reference.

### FIELD OF THE INVENTION

The present disclosure relates to additive manufacturing. Embodiments encompass calibrations in laser systems used for additive manufacturing.

### BACKGROUND OF THE INVENTION

For three-dimensional (“3D”) laser printing, the prior art provides examples of how to calibrate a laser beam that is directed to a print medium to create a printed component.

In one example, the prior art relies on manual placement of a calibration template into the 3D printer. The calibration template permits calibration of the actual location of the laser beam on a print medium with respect to idealized locations for the laser beam on the print medium.

The prior art does not provide a device and/or method that permits frequent and automated calibration of a laser beam that is focused into the print medium to create a printed component.

### SUMMARY OF THE INVENTION

The present invention addresses one or more of the deficiencies in the prior art.

The present invention provides a 3D printer that includes a print bed adapted to receive a layer of print medium thereon. The 3D printer also includes a recoater adapted to distribute the print medium onto the print bed to form the layer and a laser source adapted to generate a non-interactive laser beam and an interactive laser beam, where the non-interactive laser beam does not alter the print medium, and where, when directed to at least one predetermined location on the layer, the interactive laser beam alters the print medium at the at least one predetermined location to form a portion of a printed component. Still further, the 3D printer includes a controller connected to the laser source to direct the interactive laser beam to the at least one predetermined location. Next, the 3D printer includes a plurality of fiducial features associated with the recoater, where the plurality of fiducial features is presented by the recoater while the recoater distributes the print medium on the print bed to form the layer. Finally, the 3D printer includes a scanner connected to the controller to detect, via the non-interactive laser beam, the plurality of fiducial features and provide location information for locations of individual ones of the plurality of fiducial features. The controller compares the location information with predetermined position information for the individual ones of the plurality of fiducial features, calculates a deviation for each of the individual ones of the plurality of fiducial features, and performs a calibration to adjust where the interactive laser beam is directed to the print medium.

In one contemplated embodiment, the plurality of fiducial features encompasses a pattern of geometrical shapes.

In another embodiment, the plurality of fiducial features comprises a grid pattern.

In addition, it is contemplated that the 3D printer according to the present invention may be configured so that the print bed is adapted to receive a plurality of layers of the print medium. Here, the plurality of fiducial features is contemplated to form different patterns for different ones of the plurality of layers of the print medium.

Still further, the 3D printer may include a fiducial sheet housing with a fiducial sheet connected, at a first end, to the recoater and, at a second end, to the fiducial sheet housing. Here, the plurality of fiducial features is disposed on the fiducial sheet. In this embodiment, the fiducial sheet is flexible and may be retracted into the fiducial sheet housing. Moreover, the fiducial sheet may be rolled up into the fiducial sheet housing.

In a further contemplated embodiment, the fiducial sheet is rigid. If so, the fiducial sheet may be metal or glass.

In still another contemplated embodiment, the 3D printer includes an encoder connected to the recoater that has a recoater surface. The plurality of fiducial features is disposed on the recoater surface. In this embodiment, a stop switch may be connected to the encoder. The stop switch ceases advancement of the recoater when the recoater reaches a predetermined position.

Next, it is contemplated that the 3D printer may be constructed to that an encoder is connected to the recoater having a recoater blade. The plurality of fiducial features is disposed on the recoater blade. Here again, a stop switch may be connected to the encoder to cease advancement of the recoater when the recoater reaches a predetermined position.

In another contemplated embodiment, the 3D printer includes a print bed adapted to receive a layer of print medium thereon and a recoater adapted to distribute the print medium onto the print bed to form the layer. This 3D printer also includes a laser source adapted to generate a non-interactive laser beam and an interactive laser beam. The non-interactive laser beam does not alter the print medium. When directed to at least one predetermined location on the layer, the interactive laser beam alters the print medium at the at least one predetermined location to form a portion of a printed component. This embodiment also includes a controller connected to the laser source to direct the interactive laser beam to the at least one predetermined location. Here, a plurality of photodiodes is disposed on the recoater. The plurality of photodiodes detects impingent positions of the noninteractive laser beam thereon at predetermined positions of the recoater. The controller compares the location information with the impingement positions, calculates a deviation for each of impingement positions, and performs a calibration to adjust where the interactive laser beam is directed to the print medium.

The present invention also provides for a 3D printer that includes a print bed adapted to receive a layer of print medium thereon, a recoater adapted to distribute the print medium onto the print bed to form the layer, and a laser source adapted to generate a laser beam. The laser beam, when directed to at least one predetermined location on the layer, alters the print medium at the at least one predetermined location to form a portion of a printed component. A controller is connected to the laser source to direct the laser beam to the at least one predetermined location. A plurality of photodiodes is disposed on the recoater. The plurality of photodiodes detects impingent positions of the laser beam thereon at predetermined positions of the recoater. The controller compares the location information with the impingement positions, calculates a deviation for each of impingement positions, and performs a calibration to adjust where the laser beam is directed to the print medium.

### BRIEF DESCRIPTION OF THE DRAWINGS

The present invention is described in connection with the drawing appended hereto, in which:

FIG. 1 is a graphical, side view of a 3D printer according to the present invention, shown at a time after the deposition of a first layer of print medium on a print bed thereof;

FIG. 2 is a graphical, side view of the 3D printer illustrated in FIG. 1, shown at a time when an interactive laser beam is projected onto the first layer of the print medium;

FIG. 3 is a graphical, side view of the 3D printer illustrated in FIG. 1, shown at a time after the creation of a portion of a printed component from the first layer of the print medium;

FIG. 4 is a graphical, side view of the 3D printer illustrated in FIG. 1, shown at a time after the deposition of a second layer of the print medium atop the first layer and at a time when a calibration template has been introduced above the second layer;

FIG. 5 is a graphical, side view of the 3D printer illustrated in FIG. 1, shown at a time when the interactive laser beam is projected onto the second layer of the print medium;

FIG. 6 is a graphical, side view of the 3D printer illustrated in FIG. 1, shown at a time after the creation of a portion of a printed component from the second layer of the print medium;

FIG. 7 is a graphical representation of a calibration template used for a scanner calibration routine known in the prior art;

FIG. 8 is a graphical representation of another calibration template used according to a separate calibration process known to the prior art;

FIG. 9 is a graphical representation of a prior art scan across a fiducial feature to enable determination of the feature location;

FIG. 10 is a graphical representation of a first embodiment of the present invention using a fiducial sheet to assist with calibration of the projected location of the interactive laser beam onto the print medium;

FIG. 11 is a graphical representation of a second embodiment of the present invention using fiducial features to assist with calibration of the projected location of the interactive laser beam onto the print medium;

FIG. 12 is a graphical representation of a third embodiment of the present invention using photodiodes to assist with calibration of the projected location of the interactive laser beam onto the print medium;

FIG. 13 is a graphical representation of the use of overlapping scan fields to calibrate the operation of the laser source;

FIG. 14 is a first illustration that juxtaposes laser spots with fiducial features, providing representative electrical signal plots generated in association therewith;

FIG. 15 is a second illustration that juxtaposes laser spots with fiducial features, providing representative electrical signal plots generated in association therewith

FIG. 16 is a graphical illustration of a QUAD detector that may be employed in one or more embodiments of the present invention;

FIG. 17 illustrates several examples of laser spots projected onto the photosensitive quadrants of the QUAD detector illustrated in FIG. 16;

FIG. 18 is a graphical representation of a first construct for calculating an XY offset between a photodiode an a surface of a print medium according to one aspect of the present invention; and

FIG. 19 is a graphical representation of a second construct for calculating an XY offset between a photodiode an a surface of a print medium according to another aspect of the present invention.

### DETAILED DESCRIPTION OF EMBODIMENT(S) OF THE INVENTION

The present invention will now be described in connection with several examples and embodiments. The present invention should not be understood to be limited solely to the examples and embodiments discussed. To the contrary, the discussion of selected examples and embodiments is intended to underscore the breadth and scope of the present invention, without limitation. As should be apparent to those skilled in the art, variations and equivalents of the described examples and embodiments may be employed without departing from the scope of the present invention.

In addition, aspects of the present invention will be discussed in connection with specific materials and/or components. Those materials and/or components are not intended to limit the scope of the present invention. As should be apparent to those skilled in the art, alternative materials and/or components may be employed without departing from the scope of the present invention.

In the illustrations appended hereto, for convenience and brevity, the same reference numbers are used to refer to like features in the various examples and embodiments of the present invention. The use of the same reference numbers for the same or similar structures and features is not intended to convey that each element with the same reference number is identical to all other elements with the same reference number. To the contrary, the elements may vary from one embodiment to another without departing from the scope of the present invention.

Still further, in the discussion that follows, the terms “first,” “second,” “third,” etc., may be used to refer to like elements. These terms are employed to distinguish like elements from similar examples of the same elements. For example, one fastener may be designated as a “first” fastener to differentiate that fastener from another fastener, which may be designated as a “second fastener.” The terms “first,” “second,” “third,” are not intended to convey any particular hierarchy between the elements so designated.

It is noted that the use of “first,” “second,” and “third,” etc., is intended to follow common grammatical convention. As such, while a component may be designated as “first” in one instance, that same component may be referred to as “second, “third,” etc., in a separate instance. The use of “first,” “second,” and “third,” etc., therefore, is not intended to limit the present invention.

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items. The systems, apparatus, and methods described herein should not be construed as limiting in any way. Instead, the present disclosure is directed toward all novel and non-obvious features and aspects of the various disclosed embodiments, alone and in various combinations and sub-combinations with one another. The term “or” refers to “and/or,” not “exclusive or” (unless specifically indicated).

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation. Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatuses.

Additionally, the description sometimes uses terms like “produce” and “provide” to describe the disclosed methods. These terms are high level abstractions of the actual operations that are performed. The actual operations that correspond to these terms will vary depending on the particular implementation and are readily discernible by one of ordinary skill in the art. In some examples, values, procedures, or apparatuses are referred to as “lowest,” “best,” “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation.

Scanner calibration within known three-dimensional powder bed fusion (“3D PBF”) printing systems may be performed between build cycles, and may require the assessment of a sample piece that is inserted into and removed from the machine to evaluate calibration quality. Depending on methodology, the temporary item may or may not require additional analysis outside of the machine to complete the calibration process.

Manually adding a temporary item into a chamber to assess scanner calibration significantly affects a user's ability to perform a calibration during the build of a part, and therefore limits the frequency of calibration.

Since build cycles can typically take many days, build processes may depend on the machinery maintaining calibration without verification. A lack of calibration verification during long build cycles presents a risk to the parts being produced and requires very robust mechanical structures that increase the overall cost and complexity of the 3D printing machine.

The present invention addresses, among other things, a need for periodic calibration of 3D printing machines, especially when the 3D printing machine is used for a long duration and/or complex manufacturing process.

In various embodiments described herein, a calibration process may be performed during the build process. This may help ensure scanner accuracy over long periods of time and may reduce the risk of building parts that are out-of-spec.

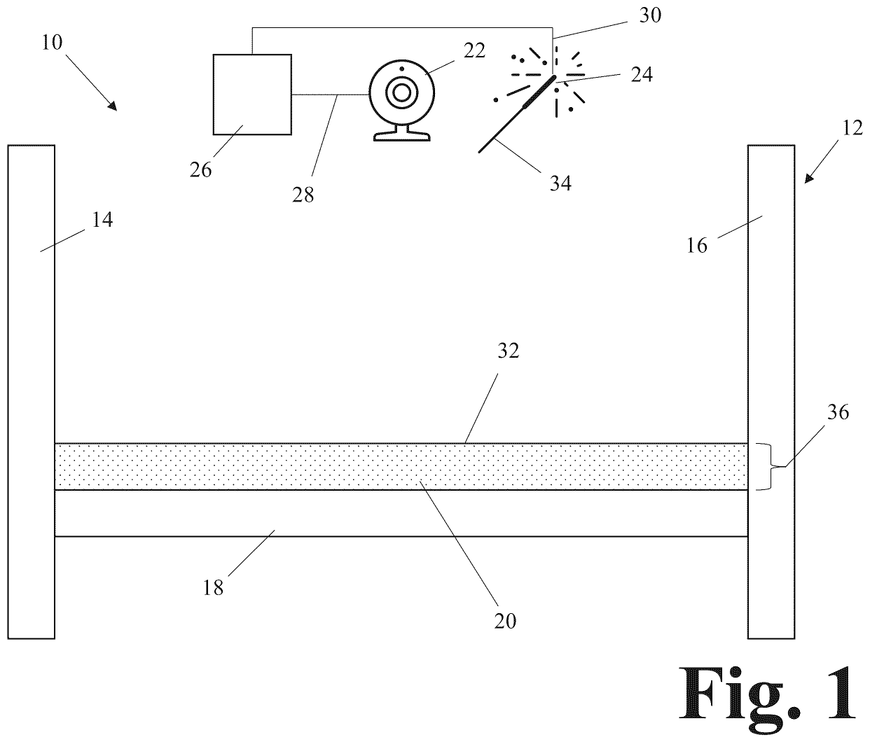

The present invention encompasses a three-dimensional printer 10 (3D printer 10), the operation of which is discussed in connection with FIGS. 1-6.

FIG. 1 is a graphical representation of a 3D printer according to the present invention. The 3D printer 10 is illustrated in a vertical cross-section.

The 3D printer 10 includes a print enclosure 12. The print enclosure 12 has walls 14, 16 that surround a print bed 18. A print medium 20 is deposited on the print bed 18 and is retained in the print enclosure 12 by the walls 14, 16.

It is noted that the size and shape of the enclosure 12 and the print bed 18 are not relevant to the present invention. The present invention is contemplated to be applicable to the manufacture of small parts, such as a valve, to larger components, such as a rocket engine.

The print medium 20 may be any material suitable for additive manufacturing, as should be apparent to those skilled in the art. The print medium 20 may be, for example, powdered metal including, but not limited to iron, aluminum, titanium, copper, zirconium, magnesium, alloys thereof, and combinations thereof.

To simplify the instant discussion, the present invention is described in connection with the use of a metal powder as a non-limiting example of the print medium 20. While the 3D printer 10 is described in this fashion, it is noted that the present invention is not limited to the use of metal powder. Other print media 20 are contemplated to fall within the scope of the present invention. For example, the 3D printer may fashion components from resin and/or plastic powder. Still further, the present invention is contemplated to be applicable to 3D printers 10 that employ a liquid, such as a liquid resin, as the print medium 20 instead of a powder. The print medium 20 also may be a combination of liquid and solid materials, as may be required and/or desired.

The 3D printer 10 includes a scanner 22, a laser source 24, and a controller 26. The scanner 22 is connected to the controller 26 via a first communication link 28. The laser source 24 is connected to the controller via a second communication link 30.

The scanner 22 is contemplated to be a camera that detects light within the print enclosure 12 at a position on or near to the surface 32 of the print medium 20. It is contemplated that the light may be provided by an ambient light source, as should be apparent to those skilled in the art. Separately, the scanner 22 may emit light that the scanner 22 detects.

In the contemplated embodiment of the 3D printer 10 of the present invention, the laser source 24 is contemplated to provide the illumination for the scanner 22. Specifically, the laser source 24 is contemplated to emit laser light that does not affect the print medium 20 but is of a sufficient intensity to be detected by the scanner 22. Without limiting the present invention, the laser source 24 may emit light of a low intensity such that the laser light does not affect the print medium 20. Alternatively, the laser light may be of a particular frequency that does not affect the print medium 20. For example, the light may have a frequency in the infra red or ultra violet portions of the electromagnetic spectrum.

In the paragraphs that follow, the scanner 22 will be described as a camera or a light detector (e.g., a photodiode or several photodiodes). However, the discussion of the scanner 22 as a camera or as a light detector should not be understood to limit the scope of the present invention. The present invention is contemplated to encompass any of a wide variety of types of scanners 22 without limitation.

The laser source 24 may be of any type capable of two functions. First, the laser source 24 is contemplated to emit a laser beam 33 that may be reflected from a position on or near the print medium 20 without altering the print medium 20. The reflected light is detected by the scanner 22. For clarity, the laser beam 33 also referred to herein as a non-interactive laser beam 33, meaning that the laser beam 33 does not interact with the print medium 20. Second, the laser source 24 is contemplated to emit a laser beam 34 with sufficient intensity that the laser beam 34 alters the print medium 20 to create a printed product PC, as discussed in greater detail hereinbelow. This is also referred to as an interactive laser beam 34, because the laser beam 34 changes the properties of the print medium 20.

For clarity, the non-interactive laser beam 33 need not be of a type that has no interaction with the print medium 20. For purposes of the present invention, the term “non-interactive” means that the laser light does not alter the properties of the print medium 20 so as to produce a portion of a printed component PC.

It is noted that the laser source 24 may be a single laser generator that is capable of generating both the non-interactive laser beam 33 and the interactive laser beam 34. Alternatively, the laser source 24 may incorporate two separate laser beam generators, one for the non-interactive laser beam 33 and one for the interactive laser beam 34. Still further, the laser source 24 may generate only the interactive laser beam 34, but also incorporate an optic device that dims the intensity of the interactive laser beam 34 to create the non-interactive laser beam 33. As should be apparent to those skilled in the art, the laser source 24 may have any number of configurations to generate the non-interactive laser beam 33 and the interactive laser beam 34. The present invention is not considered to be limited to any one particular configuration.

The controller 26 may be any suitable computing device (including a processor) that is capable of receiving input data and executing instructions to operate the 3D printer 10. The controller 26 is contemplated to receive input from the scanner 22, to process that input, and to provide instructions to direct the laser beam 33, 34 generated by the laser source 24 onto the surface 32 of the print material 20.

The first communication link 28 connects the scanner to the controller 26. The first communication link 28 is contemplated to be a bi-directional link to provide electronic signals from the scanner 22 to the controller 26 and vice-versa. However, the first communication link 28 may be unidirectional without departing from the scope of the present invention.

The second communication link 30 connects the laser source 24 to the controller 26. The second communication link 30 also is contemplated to be a bi-directional link to provide electronic signals from the laser source 24 to the controller 26 and vice-versa. However, the second communication link 30 may be unidirectional without departing from the scope of the present invention.

The first communication link 28 and the second communication link 30 are contemplated to be wired links to the controller 26. However, these communication links 28, 30 may be wireless without departing from the scope of the present invention. Moreover, these communication links 28, 30 may combine wired and wireless components, as should be apparent to those skilled in the art.

As illustrated in FIG. 1, the print enclosure 12 has been provided with a first layer 36 of the print medium 20 on the print bed 18. The first layer 36 of the print medium 20 is contemplated to be a thin layer, with a surface 32, that is appropriate for the manufacture of the printed component PC.

FIG. 1 illustrates the 3D printer 10 before a first application of the interactive laser beam 34 to the print medium 20. In this illustration, the print medium 20 is entirely in powdered (or liquid) form, as appropriate for manufacturing the printed component PC.

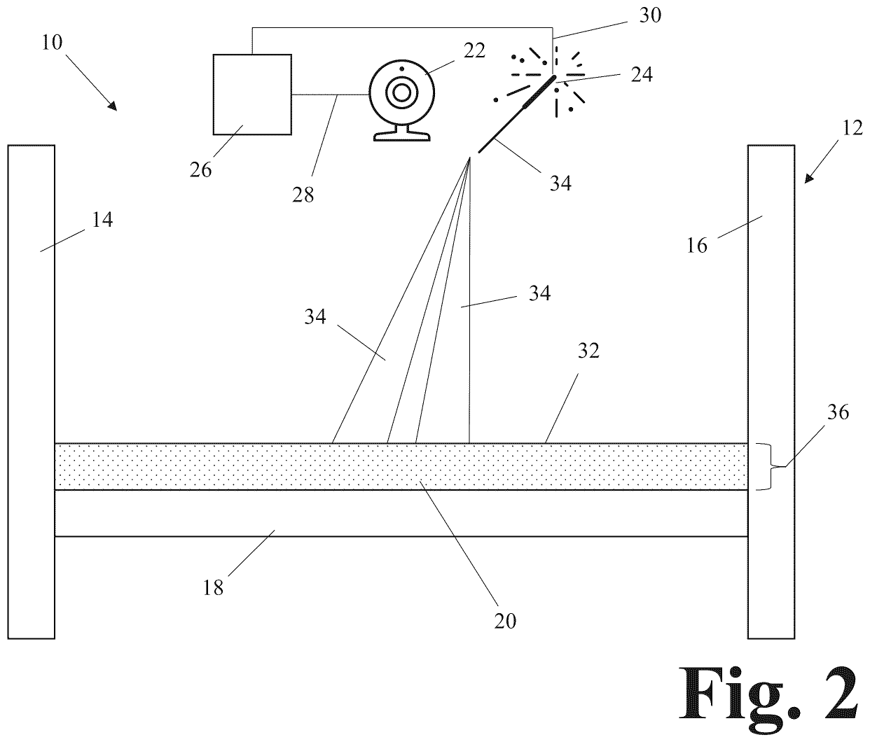

FIG. 2 is a vertical cross-section of the 3D printer 10 illustrated in FIG. 1.

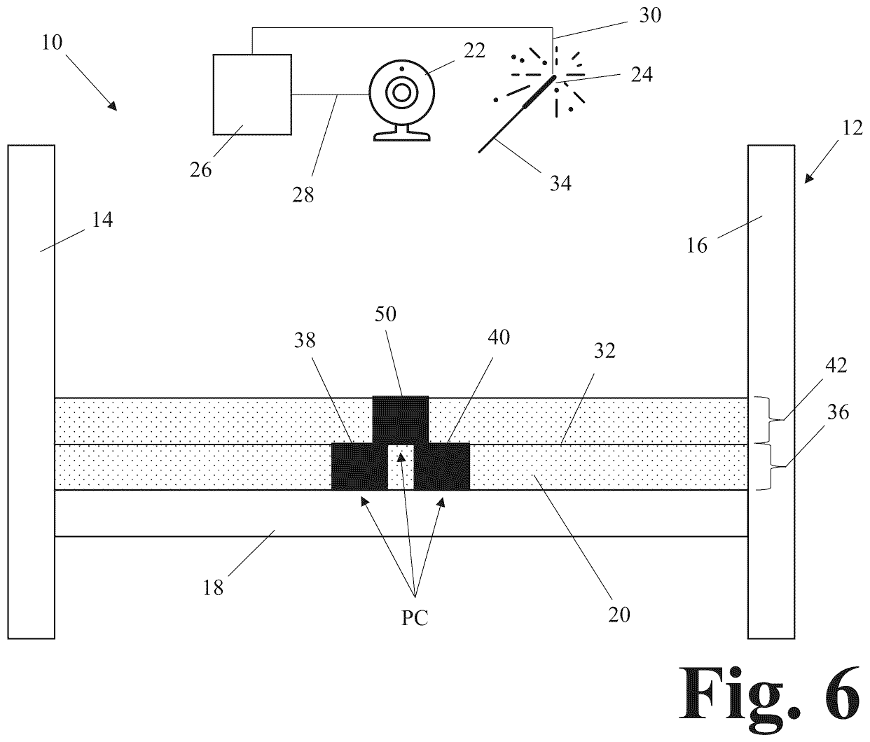

In FIG. 2, the laser source 24 has been activated by the controller 26 to direct the interactive laser beam 34 to the print medium 20. The interactive laser beam 34 causes the print medium 20 to consolidate and form one layer of the printed component PC, which is shown in FIG. 6.

In the case, as here, where the print medium 20 is a powdered metal, the interactive laser beam 34 melts the powdered metal to form a molten material. The molten material then solidifies to consolidate and form a portion of the printed component PC. Specifically, the molten material solidifies to form one layer of the printed component PC.

As should be apparent from FIG. 2, the interactive laser beam 34 impinges on the first layer 36 of the print medium 20.

FIG. 2 illustrates a point in time after the condition of the 3D printer as shown in FIG. 1.

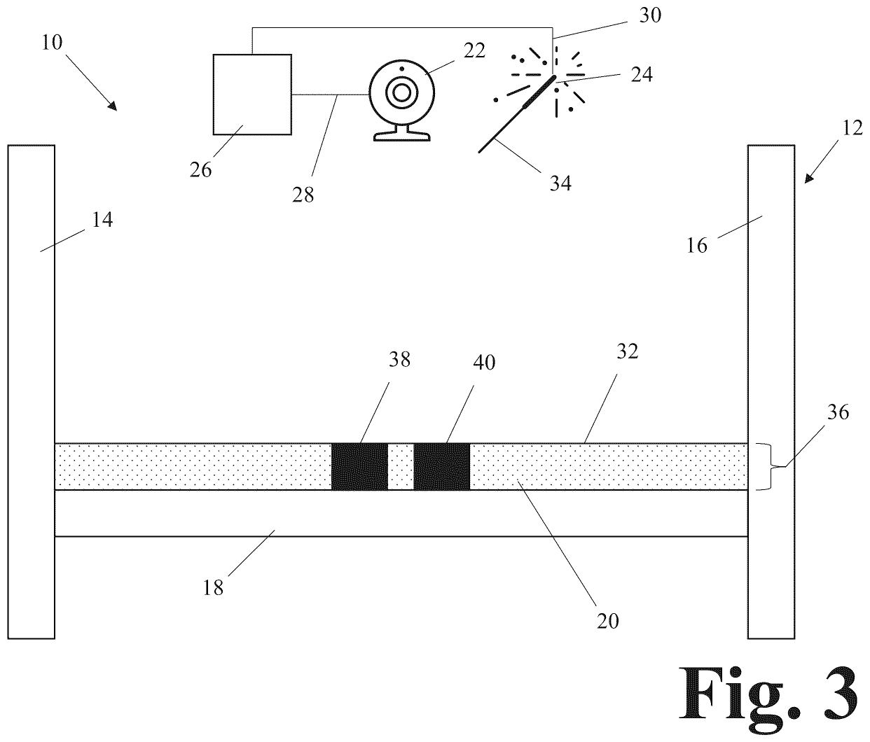

FIG. 3 is a vertical cross-section of the 3D printer illustrated in FIG. 1.

FIG. 3 illustrates a point in time after the interactive laser beam 34 is deactivated, following the operation illustrated in FIG. 2.

In particular, FIG. 3 illustrates the state after the interactive laser beam 34 is deactivated, and the printed material 20 has solidified into a first portion 38 of the printed component PC and a second portion 40 of the printed component PC. As illustrated, the print medium 20 on which the interactive laser beam 34 was not focused remains unaffected. In other words, where the printed medium 20 is a powdered metal, the portions of the print medium 20 not impacted by the interactive laser beam 34 remain as powdered metal.

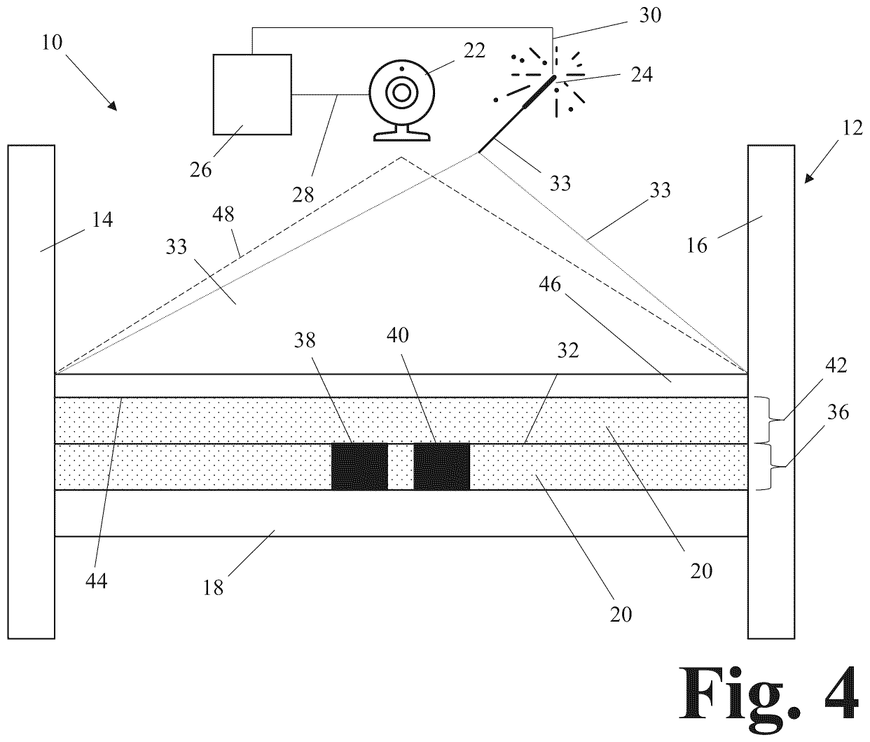

FIG. 4 is a vertical cross-section of the 3D printer illustrated in FIG. 1.

FIG. 4 illustrates a moment after a second layer 42 of the print medium 20 has been deposited onto the first layer 36. The second layer 42 of the print medium 20 has a surface 44.

In FIG. 4, a calibration template 46 has been introduced between the scanner 22 and the second layer 42 of the print medium 20. Details of the calibration template 46 are provided below.

The calibration template 46 introduces a fiducial pattern that, when illuminated by the laser source 24 using the non-interactive laser light 33, permits detection of a fiducial pattern that is used by the controller 26 to direct the interactive laser beam 34 onto the print medium 20. The calibration template 46 permits the controller 26 to adjust the location(s) where the interactive laser beam 34 strikes the print medium 20.

In FIG. 4, the calibration template 46 is positioned between the scanner 22 and the second layer 42 of the print medium 20. Here, the scanner 22 has been activated, as indicated by the illustration of the scanner region 48.

The non-interactive laser beam 33 has been activated to illuminate the calibration template 46. The scanner 22 detects light reflected from (or absorbed by) the calibration template 46 (i.e., the fiducial features, discussed below) to assess if the non-interactive laser light 33 is in register with the fiducial features. In this manner, the controller 26 may make calibration adjustments to the focusing of the interactive laser light 34 to assure that the interactive laser light 34 is directed to the correct location(s) on the print medium 20.

In summary, FIG. 4 illustrates a calibration stage in the operation of the 3D printer 10.

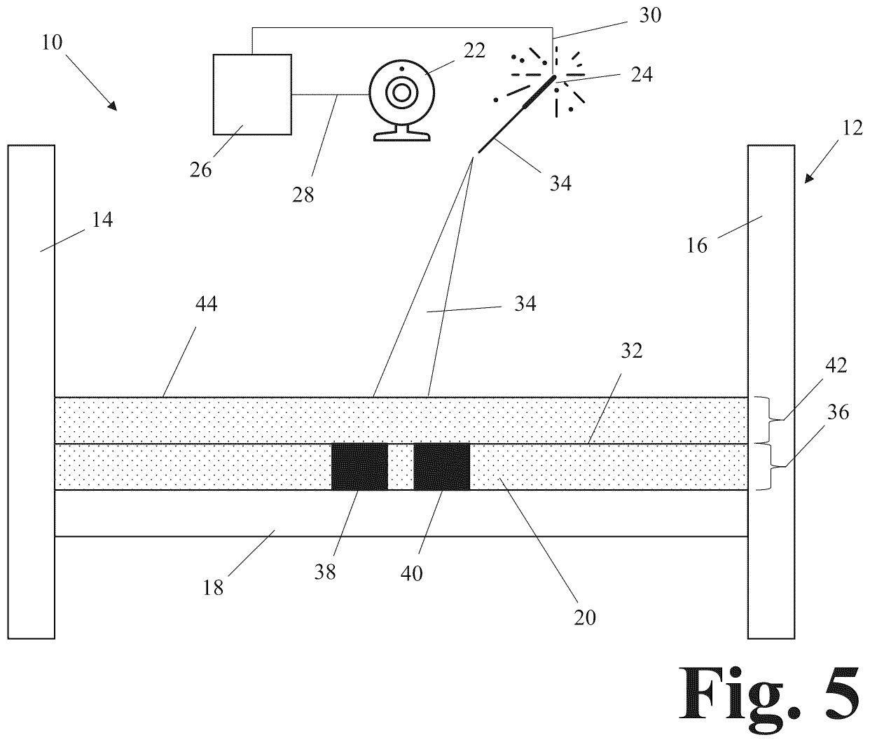

FIG. 5 is a vertical cross-section of the 3D printer 10 illustrated in FIG. 1.

FIG. 5 depicts the operation of the 3D printer 10 after calibration adjustments have been made by the controller 26.

In FIG. 5, the laser source 24 has been activated a second time by the controller 26 to direct the interactive laser beam 34 onto the print medium 20. In this illustration, the calibration template 46 has been removed, and the interactive laser beam 34 is being directed to the surface 44 of the second layer 42.

As before, the interaction between the interactive laser light 34 and the print medium 20 causes the properties of the print medium 20 to change, thereby forming another portion of the printed component PC.

FIG. 6 is a vertical cross-section of the 3D printer 10 illustrated in FIG. 1.

Following the application of the interactive laser light 34, at a point in time after the print medium (e.g., the powdered metal) melts 20 and solidifies, a third portion 50 of the printed component PC is formed in the second layer 42 of the print medium 20.

In FIG. 6, the printed component PC is illustrated as the combination of the first portion 38, the second portion 40, and the third portion 50. In this simplified depiction of the operation of the 3D printer 10, the printed component PC contains three portions, the first portion 38, the second portion 40, and the third portion 50. As should be apparent to those skilled in the art, the printing of a printed component PC may involve hundreds or thousands of individual layers of printed medium.

After the third portion 50 is printed, as illustrated in FIG. 6, additional, successive layers of the print medium 20 may deposited and altered by the interactive laser beam 34. The calibration template 46 may be inserted into the 3D printer 10, as illustrated in FIG. 4, periodically during the additive manufacturing process. For example, the calibration template 46 may be inserted after each application of the interactive laser beam 34 to the print medium 20. Alternatively, the calibration template 46 may be inserted at predetermined intervals, as deemed appropriate for the particular printed component PC and the calibration drift experienced for the 3D printer 10. Still further, as discussed in greater detail hereinbelow, different calibration templates 46 may be employed depending on the distance between the laser source 24 and the print medium 20 to assure accurate additive manufacturing.

The process of additive manufacturing illustrated in FIGS. 1-6 is repeated until the printed component PC is complete.

The present invention addresses one potential issue that may arise when printing a printed component PC. Specifically, as identified above, when the laser beam 34 is applied to successive layers of the print medium 20, it is possible for the laser beam 34 to deviate, or “drift,” from the position required to print the printed component PC. To correct any deviations of the laser beam 34 from ideal locations, it is necessary to calibrate the operation of the laser source 24 periodically so that the interactive laser beam 34 is focused on the correct location(s) on the print medium 20.

As discussed in greater detail below, calibration is accomplished via periodic use of the calibration template 46 or different versions of the calibration template 46.

The present invention differs from the prior art in many ways from the prior art. Among the differences, the present invention incorporates automated calibration for the laser source 24.

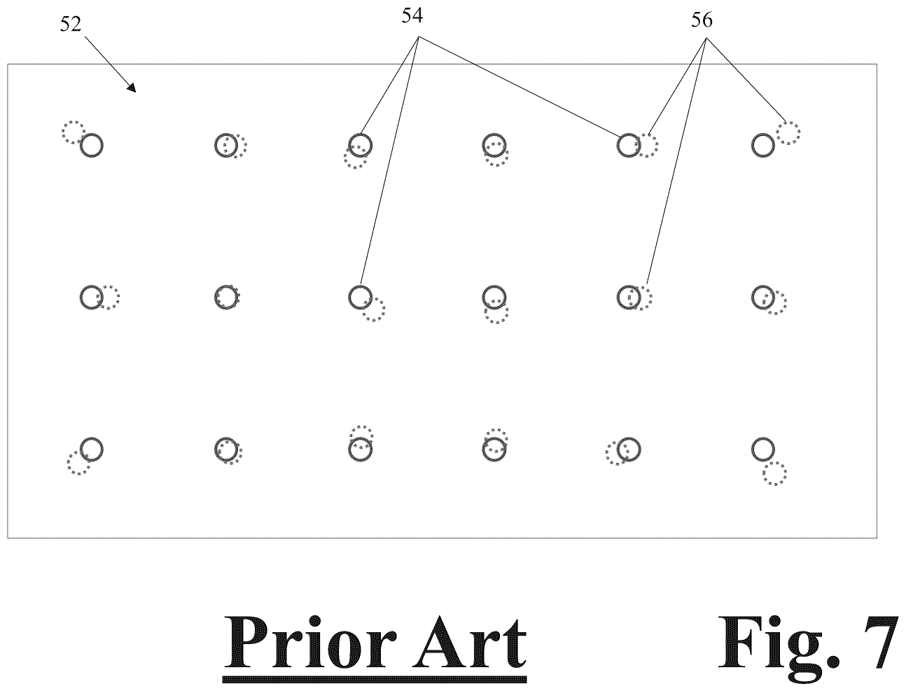

Before discussing the calibration provided by the present invention, a brief overview of prior art calibration is discussed in connection with FIGS. 7-9.

In the prior art, it is known that a scanner calibration routine may be employed to ensure that the commanded beam location is the same as (or very close to) the actual beam location across the whole scan field. Some prior art calibration processes require a user to manually insert a plate or a sheet of material into the machine at a defined location and orientation. The material is marked with a fiducial pattern of known dimensions. After the calibration is complete, the plate or sheet of material is removed from the machine.

During calibration, markings on the material are measured by a high-resolution scanner (or other device) to determine the position error for each mark in all of the areas of the scan field.

FIG. 7 is a graphical illustration of one calibration template 52 that is consistent with the scanner calibration routine known in the prior art. The calibration template 52 typically is an sheet of material onto which the laser beam is focused. In particular, FIG. 7 depicts commanded mark locations (solid lines) 54 and also actual mark locations (dotted lines) 56 made by a laser beam onto the calibration template 52.

It is noted that the commanded mark locations 54 do not actually appear on the calibration template 52. Only the actual mark locations 56 appear on the calibration template 52 after activation of the laser beam.

As should be apparent to those skilled in the art, the processor that executes the prior art scanner calibration routine understands where the laser beams are supposed to focused on the calibration template (e.g., at the commanded mark locations 54). After scanning the calibration template 52, the locations of the actual mark locations 56 are determined.

With the idealized, commanded mark locations 54 understood and the actual locations 56 measured, the X/Y error (i.e., the “drift”) between each point may be input into a calibration algorithm to create a corrected configuration file for the scanner. Sometimes the process may need to be repeated to enable best calibration, but better algorithms allow good calibration to be achieved without iteration. At the conclusion of a successful calibration, the scanner is understood to focus the laser beam at the intended location with only a small amount of error. For a scan field of 500 mm×500 mm, a calibration error <10 μm at any specific location generally is considered “good” or “very good” by the standards considered to be appropriate for the modern 3D printing industry.

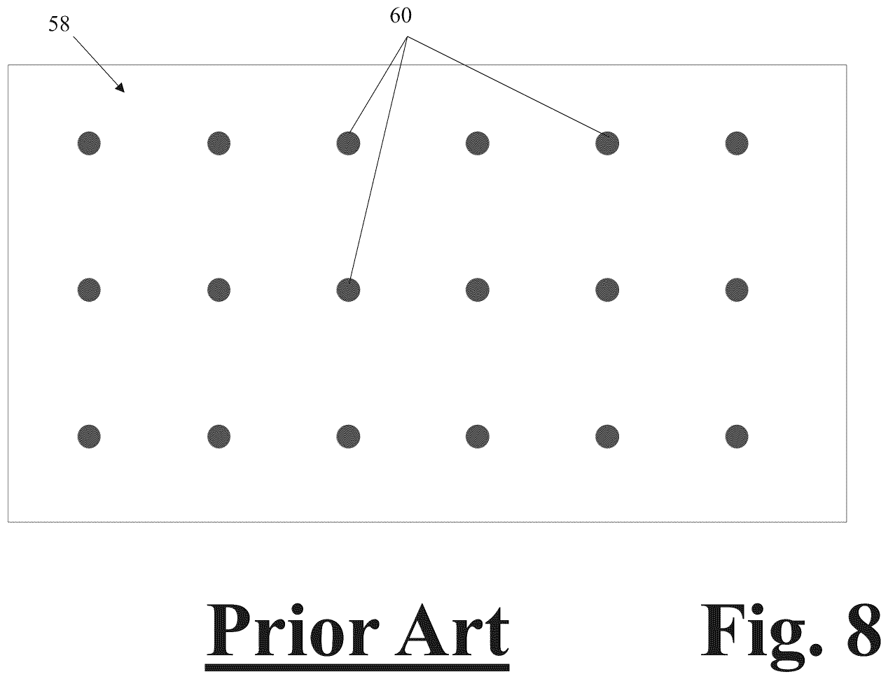

FIG. 8 illustrates a calibration template (also referred to as a “fiducial plate” or a “pre-characterized fiducial plate”) 58 that may be used according to a separate calibration process known to the prior art. As in the example illustrated in FIG. 7, the fiducial plate 58 is temporarily inserted, manually, onto the bed of the printing machine.

In this prior art calibration method, the fiducial plate 58 contains clearly defined (sharp-edged) regions 60 that are significantly co-planar but have contrasting optical characteristics. In the example shown in FIG. 8, the fiducial plate 58 is sand-blasted aluminum while the well-defined dots are pressed-in pieces of optically absorptive material. Alternatively, the fiducial plate 58 may be a single piece of glass with the contrasting regions 60 being provided via frosting and/or coatings. Generally, the method may be optimized if one of the two regions provide a diffuse reflection.

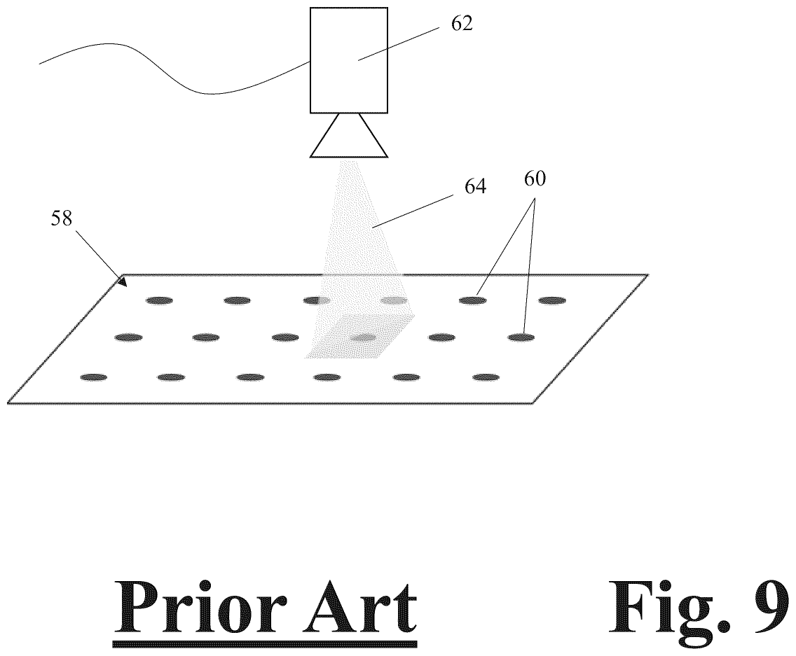

Refence is now made to FIG. 9, which illustrates a photodetector 62 in relation to the fiducial plate 58. FIG. 9 illustrates scanning across fiducial features 60 to enable determination of the features' locations by monitoring the scattered light signal.

The laser and scanner within the machine may be utilized to sweep across the high-contrast features 60 while a wide-view photodetector 62 monitors the scattered light within the build chamber. Either the primary IR beam or visible aiming beam 64 may be used at various power levels that prevent burning, ablating or melting of the fiducial plate 58. Assessment of the rise/fall signal from the photodetector 64 allows the feature location in the scan direction to be understood.

In practice, various prior art methods may be utilized to establish the X/Y location of the feature 60 via an edge detection scheme. The determined location of the feature 60 may be compared to the idealized location to determine the error map that feeds the correction algorithm. Circular features may be generally preferred, but a variety of fiducial shapes may be made to work.

Both the above prior art described methods may serve to create a high-quality between print jobs. As noted, however, the prior art requires a user to manually insert a plate or sheet into the printing machine periodically. Not only is this process time consuming, but the prior art processes rely on accurate positioning of the plate or sheet in the printing machine. Since the prior art requires insertion of the plate or sheet by a person, there is the possibility of improper insertion, which can distort any calibrations made.

The present invention provides apparatuses and methods that permit, inter alia, automation of one or more calibration processes.

As highlighted in connection with the embodiments discussed hereinbelow, a fiducial pattern is provided within a 3D scanner 10 such that the fiducial pattern is made available for frequent scanning, assessment, and calibration between print layers.

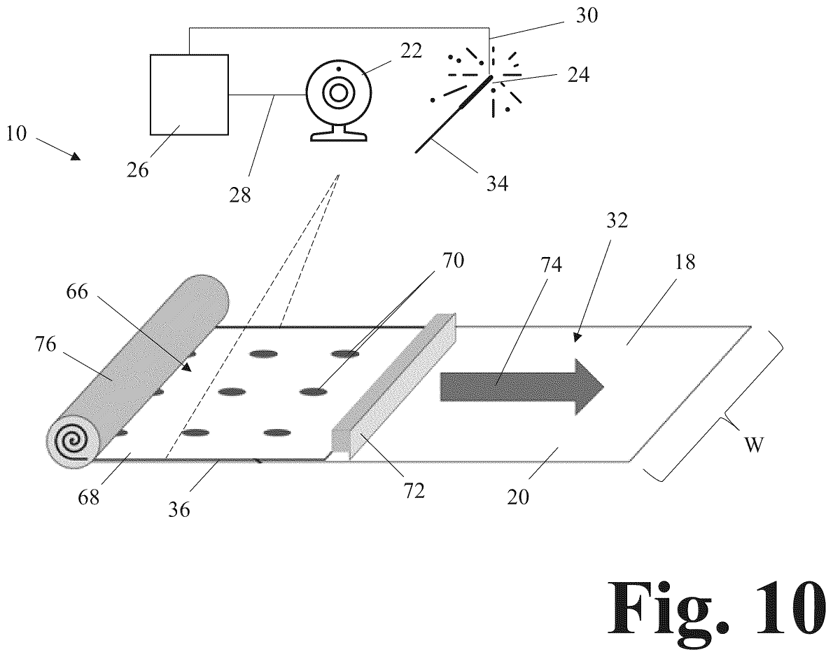

In a first embodiment of the present invention, as shown in FIG. 10, a fiducial sheet 66 may be embodied as a flexible sheet 68 containing fiducial features 70 thereon.

In the illustrated example, the fiducial features 70 are illustrated as high-contrast circular regions. It is noted that this example is a non-limiting embodiment. The fiducial features 70 may have any suitable shape and pattern. Moreover, the fiducial features 70 may present and/or incorporate a grid as required and/or desired.

In this first embodiment, the fiducial sheet 66 is contemplated to be connected to a recoater 72. A recoater 72 is a device that spans the width W of the print bed 18 and smooths or “squeegees” the print medium 20 onto the print bed 18 to form a uniformly thick layer, such as the first layer 36.

As illustrated, the recoater 72 travels in the direction of the arrow 74. The fiducial sheet 66 is connected to the recoater 72 at a first end. At a second end, the fiducial sheet 66 is rolled up in a fiducial sheet housing 76. As the recoater 72 moves in the direction of the arrow 74, the fiducial sheet 66 is unrolled from the fiducial sheet housing 76, thereby exposing the fiducial features 70 to the scanner 22.

In this first embodiment, a fiducial sheet 66 is moved into an out of the scanner field of the scanner 22 each time the recoater 72 moves to smooth the surface 32 of the print medium 20. As a result, each time a new layer of the print medium 20 is deposited onto the print bed 18, the fiducial features 70 are exposed to the scanner 20. For this reason, each time a new layer of print medium 20 is deposited onto the print bed 18, the scanner 20 may be employed, in an automated fashion, to adjust the calibration of the interactive laser beam 34. Alternatively, the fiducial sheet 66 may be unfurled in a periodic fashion, at predetermined time intervals or between predetermined operations of the 3D printer 10.

It is contemplated that the recoater 72 may be moved in the direction of the arrow 74 via a motor, one or more robots, and the like (not shown).

As noted, the recoater 72 is understood to unroll or unfurl the fiducial sheet 66 onto or near the powder bed to expose the fiducial features 70 to the scanner 20. As the recoater 72 retracts, the fiducial sheet 66 is rolled back into the fiducial sheet housing 76 (or otherwise relocated to a resting location) via springs or motors (not shown), for example.

Each time the fiducial sheet 66 is unfurled to a calibration position, a calibration routine may be run by the controller 26. Since the recoater 72 necessarily sweeps between the full travel limits for every layer deposited onto the print bed 18, the deposition of each layer of print medium 20 onto the print bed 18 presents an opportunity to run the calibration routine.

As discussed in connection with the first embodiment, the fiducial sheet 66 is unfurled from the fiducial sheet housing 76. However, the present invention should not be understood to be limited solely to this configuration. It is contemplated that the fiducial sheet 66 may be stored in alternative locations, packages, and/or shapes.

Without limiting the present invention, it is contemplated that an orthogonal encoder, embodied, for example, in the controller 26, may be relied upon to establish X/Y locations for the fiducial features 70.

It is also contemplated that the present invention may utilize the recoater 72 of the 3D printer 10 in other ways.

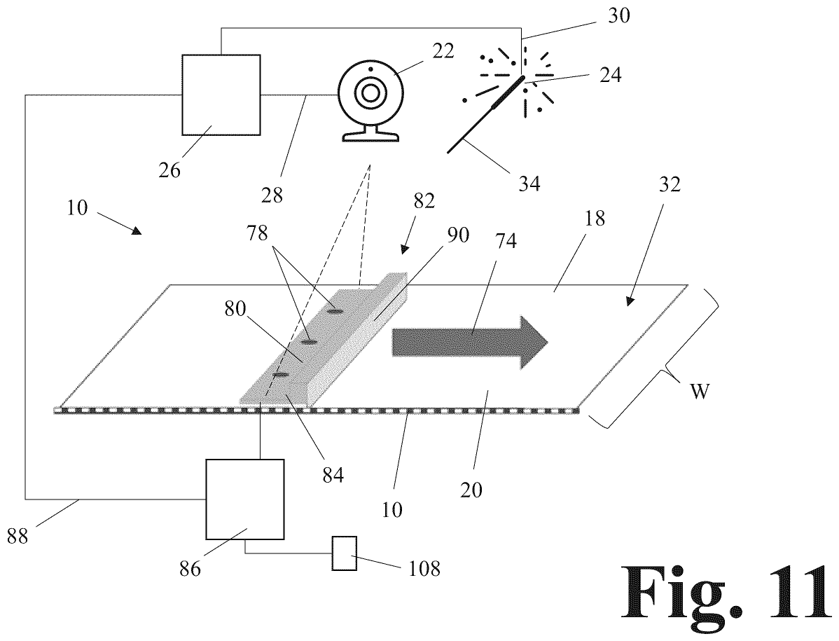

In a second embodiment of the present invention, as illustrated in FIG. 11, fiducial features 78 are provided on the surface 80 of the recoater 82. Specifically, the fiducial features 78 may be provided on a rigid calibration plate 84 that defines the surface 80 of the recoater 82. In this second embodiment, an encoder 86 is associated with the recoater 82 to provide an accurate positional location of the recoater 82 as the recoater 82 travels in the direction of the arrow 74. The encoder 86 provides the positional location of the recoater 82 to the processor 26 so that the X/Y locations of the fiducial features 78 may be determined via a suitable calibration methodology. The position information is contemplated to be provided to the controller 26 from the encoder 86 via a third communication link 88, which may be wired and/or wireless.

In the embodiment illustrated in FIG. 11, as the recoater 82 drives across the print bed 18, the scanner 22 interrogates the row of fiducial features 78 at the known locations (predetermined locations) provided by the encoder 86 attached to the recoater 82.

In another contemplated embodiment, the fiducial features 78 provided on the recoater 82 may be replaced with position sensitive photodiodes and the scanner 22 may be replaced by quadrant photo detectors. In a further contemplated embodiment, the fiducial features 78 and/or the photodiodes may be located on a powder recoat blade 90.

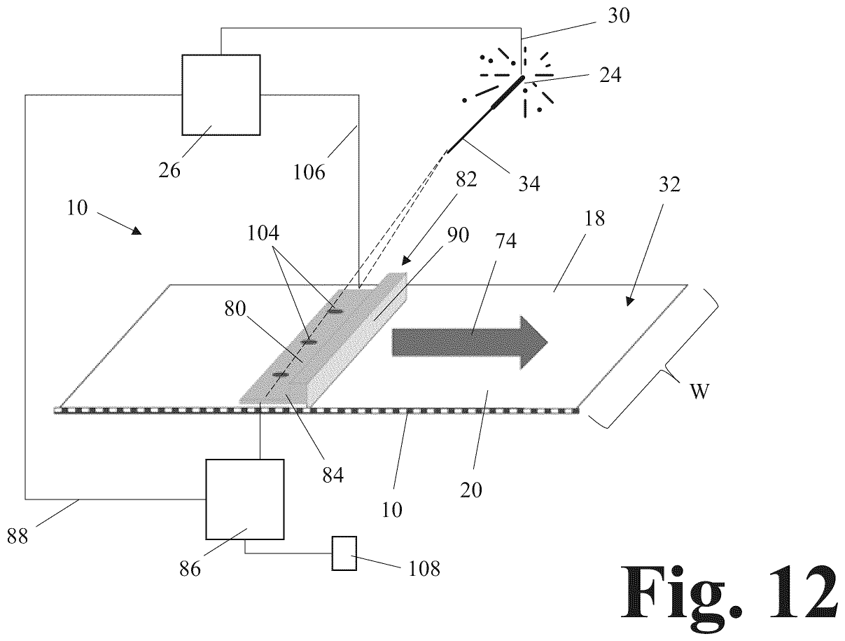

The embodiment where the fiducial features 78 are replaced by photodiodes is illustrated in FIG. 12.

The embodiment of the 3D printer 10 illustrated in FIG. 12 shares many features in common with the embodiment illustrated in FIG. 11. Here, the fiducial features 78 have been replaced by photodiodes 104 that are adapted to detect the non-interactive laser beam 33. In this embodiment, because the photodiodes 104 are provided to detect the non-interactive laser beam 33, the scanner 22 has been removed. It is noted that a scanner 22 may be used in this embodiment, as required and/or as desired.

For the embodiment illustrated in FIG. 12, the recoater 82 moves in the same manner as in the prior embodiment. The precise position of the recoater 82 is detected by the encoder 86. At specific, predetermined locations of the recoater 82 in its travel across the print bed 18 in the direction of the arrow 74, the non-interactive laser beam 33 is focused upon the photodiodes 104. The photodiodes 104 measure the focus positions of the non-interactive laser beam 33 and provide that information to the controller 26 via the fourth communication link 106. Using the positional information, the controller 26 then makes any calibration adjustment that are needed.

In this embodiment, the non-interactive laser beam 33 may be aimed at the position sensitive photodiodes either simultaneously (e.g., all at once) and/or sequentially (e.g., one at a time). The position sensitive photodiodes 104 (or quadrant photo detectors) read out the X and Y position of the non-interactive laser beam 33 with micron-level accuracy. In this embodiment, therefore, the actual laser beam position (i.e., the actual positions of the non-interactive laser beam 33) may be measured at each point, instead of depending on a scanner 22 picking up scattered light from a fiducial mark 78.

In another contemplated embodiment, the interactive laser 34 may be focused onto the photodiodes 104. Since the photodiodes 104 are provided on the recoater surface 80, the interactive laser beam 34 interacts with the recoater 82 and not the print medium 22.

In addition to accommodating calibration between layers 36, 42, contemplated embodiments described herein may provide simple and robust calibration of multiple scanners/scan fields within the 3D printer 10. The use of the same reference points for multiple scanners with field overlap (or field handoff) locations effectively may eliminate the complexity of “stitching” multiple scan fields together and reduces multi-scanner calibration to a series of individual scanner calibration routines.

FIGS. 11 and 12 also include a stop switch 108 that is connected to or incorporated into the encoder 86. The stop switch 108 is provided to stop the advancement of the recoater 82, in the direction of the arrow 74, when the recoater 82 reaches a predetermined position. The predetermined position may be an intermediate position or a final position, as required or as desired to execute a suitable calibration routine.

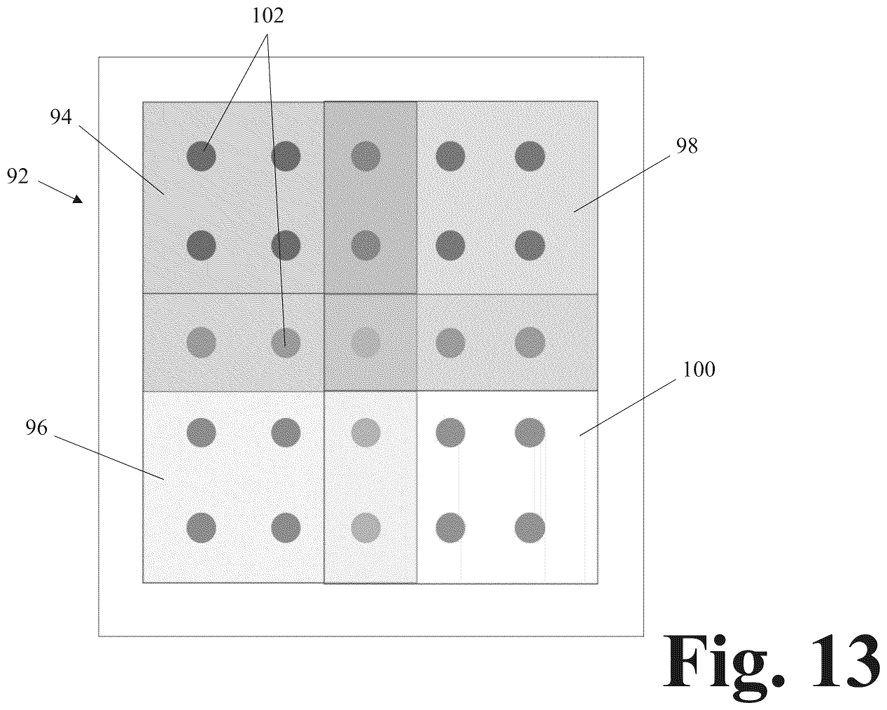

FIG. 13 is a graphical representation of the use of overlapping scan fields to calibrate the operation of the laser source 24.

As illustrated in FIG. 13, the overall scan field 92 includes four separate scan fields 94, 96, 98, 100. Each scan field 94, 96, 98, 100 encompasses nine fiducial features 102. The scan fields 94, 96, 98, 100 overlap one another.

It is contemplated that each scan field 94, 96, 98, 100 may be scanned by a separate scanner 22. Thus, individual scanner calibration routines reference the same fiducial features 102. While overlap is not required to ensure alignment between individual scan fields 94, 96, 98, 100, the use of the same fiducial features 102 for different scanners 22 may realize benefits for calibration as should be apparent to those skilled in the art. Alternatively, different fiducial features 102 may be employed without departing form the scope of the present invention.

As discussed above in connection with FIGS. 10 and 12, for example, it is contemplated that the fiducial features 70, 78 are high-contrast fiducial markings that all have the same size.

However, the present invention should not be understood to be limited to embodiments where the fiducial markings 70, 78 all have the same size. To the contrary, the fiducial markings 70, 78 may have different sizes without departing from the scope of the present invention.

When the non-interactive laser beam 33 is directed at the fiducial features 70, 78, the size of the spot created by the non-interactive laser beam 33 is contemplated to vary depending upon various factors such as the focus of the optics through which the non-interactive laser beam 33 passes.

For the present invention, a differential between the size of the fiducial features 70, 78 and the size of the spot created by the non-interactive laser beam 33 may be evaluated for calibration purposes, because the differential may result in the generation of a scattered light signal that may be used to assess the focus condition of the non-interactive beam 33.

In particular, when the non-interactive laser beam 33 is centered on an absorptive fiducial feature 70, 78 in a de-focused state, any increased focusing of the non-interactive laser beam 33 will progressively decrease the scattered light signal from the fiducial features 70, 78 as greater proportions of the non-interactive laser beam spot are absorbed by the fiducial feature 70, 78.

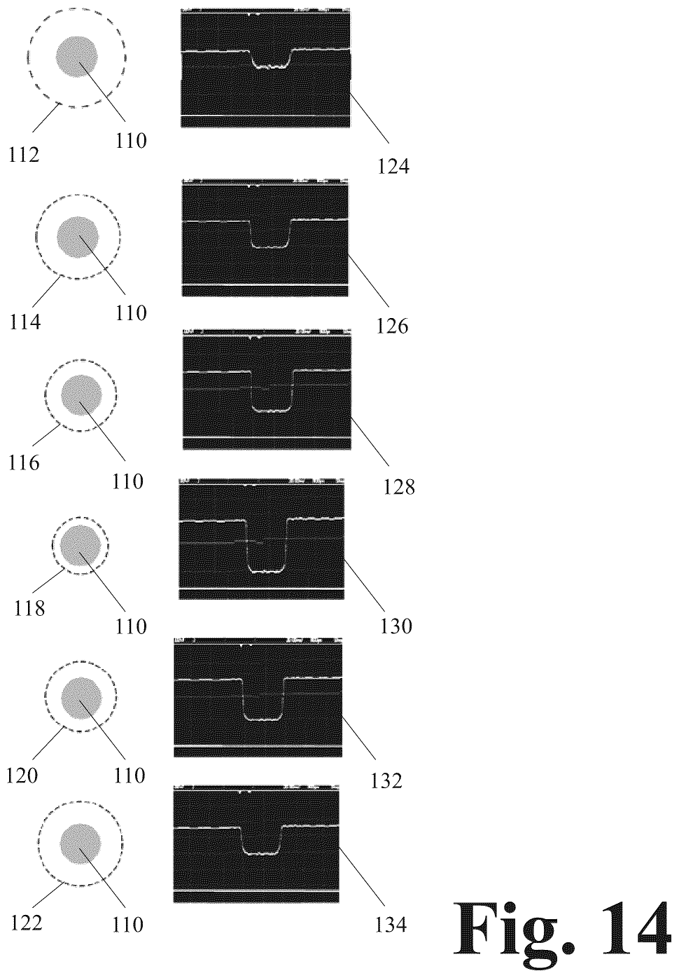

Reference is now made to FIG. 14, which helps to illustrate this principle. In FIG. 14, the fiducial features 110 are illustrated as light absorptive circles, each of which has the same diameter. The laser spots 112, 114, 116, 118, 120, 122 created by the non-interactive laser 33 are designated by the dotted line circles in FIG. 14. As illustrated, the laser spots 112, 114, 116, 118, 120, 122 in this illustration are larger in diameter than the fiducial features 110.

FIG. 14 also provides electrical signal plots 124, 126, 128, 130, 132, 134 that represent contemplated examples of the electrical signals that may be generated in response to receipt of the light reflected to the scanner 22, for example. The characteristics of the electrical signal plots 124, 126, 128, 130, 132, 134 may be employed to determine the magnitude of focus of the non-interactive laser beam 33. A larger degree of light scattering, is contemplated to be associated with the laser spot 112 by comparison with the laser spot 118, for example.

Adjustments and/or changes to the focus may be made after analyzing the electrical signal plots 124, 126, 128, 130, 132, 134.

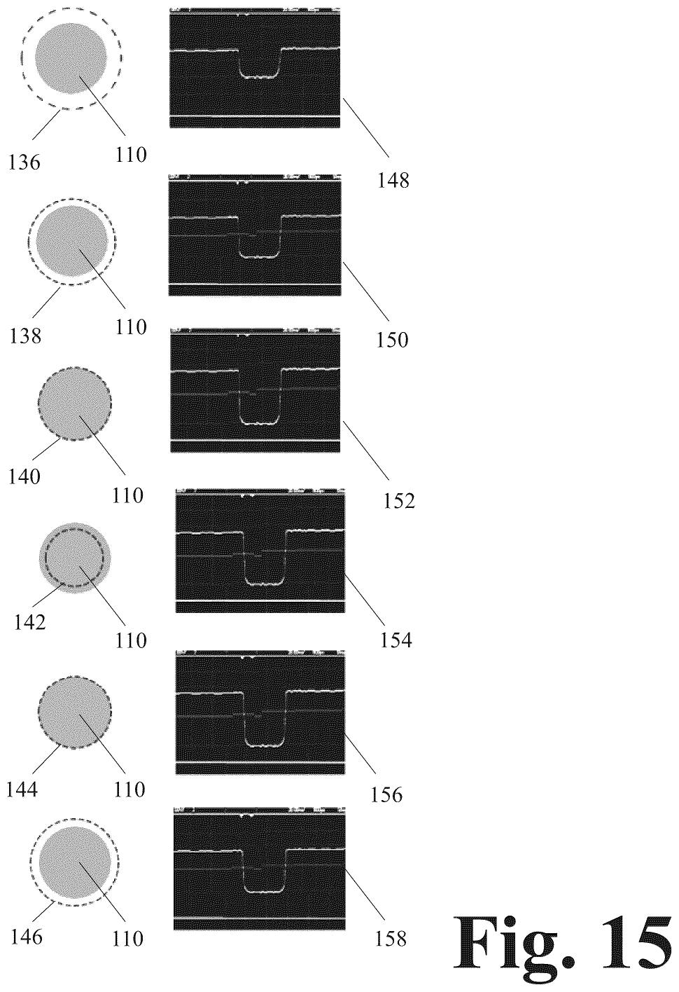

As illustrated in FIG. 15, it is equally possible that one or more of the fiducial features 110 may be equal to or larger than the laser spot 140, 142, 144. Here, the various sizes of laser spots 136, 138, 140 may be completely absorbed by the fiducial feature 110. Electrical signal plots 148, 150, 152, 154, 156, 158 are provided for the associated laser spots 136, 138, 140, 142, 144, 146. Here again, the electrical signal plots 148, 150, 152, 154, 156, 158 may be employed to adjust the focus of the non-interactive laser beam 33.

The electrical signal plots 124, 126, 128, 130, 132, 134, 148, 150, 152, 154, 156, 158 may be utilized if the non-interactive laser beam 33 is stationary or if the non-interactive laser beam 33 sweeps across the fiducial features 110.

In FIGS. 14 and 15, the laser spots 112, 114, 116, 118, 120, 122, 136, 138, 140, 142, 144, 146 are shown as circular spots. However, the present invention is not limited solely to this configuration. The laser spots 112, 114, 116, 118, 120, 122, 136, 138, 140, 142, 144, 146 may have any other shape, such as an elliptical shape, for example, without departing from the scope of the present invention.

As discussed in connection with FIG. 12, the 3D printer 10 of the present invention may employ photodiodes 104 to detect the non-interactive laser beam 33.

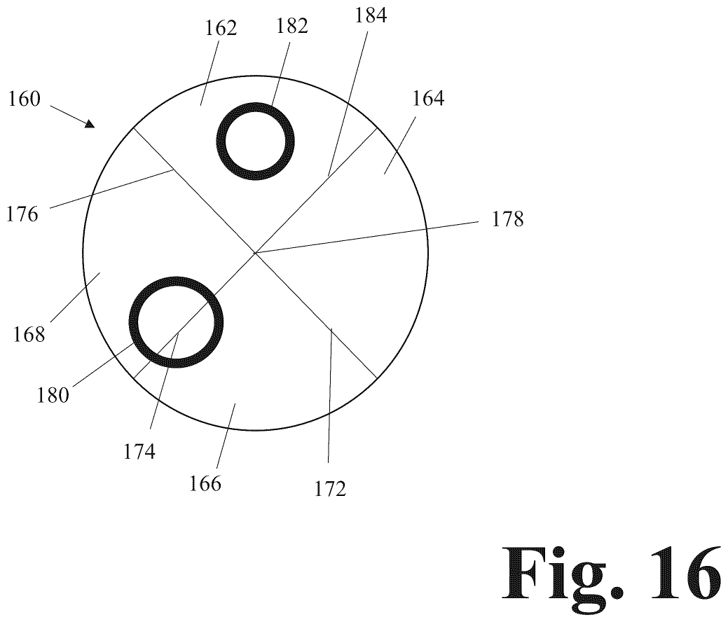

In one contemplated embodiment, the photodiode 104 is a QUAD-type photodetector, a simplified illustration of which is provided in FIG. 16.

As illustrated in FIG. 16, the QUAD detector 160 includes four photosensitive regions or quadrants. The photosensitive quadrants are designated as a first photosensitive quadrant 162, a second photosensitive quadrant 164, a third photosensitive quadrant 166, and a fourth photosensitive quadrant 168. Each of the photosensitive quadrants 162, 264, 166, 168 are electrically separated from each other along a first separation 170, a second separation 172, and third separation 174, and a fourth separation 176. Being separated electrically from one another, each of the photosensitive quadrants 162, 164, 166, 168 are able to detect light from the non-interactive laser beam 33 separately from one another. The QUAD detector 160 also has a center point 178 where the separations 170, 172, 174, 176 converge.

In FIG. 16, a first light ring 180 and a second light ring 182 of non-interactive laser light are illustrated. Because the QUAD detector 160 incorporates the four photosensitive quadrants 162, 164, 166, 168, the QUAD sensor 160 is not only capable of detecting the brightness of the light rings 180, 182, it is also capable of detecting the positions of the light rings 180, 182. As a result, the QUAD detector 160 is capable of determining the degree or magnitude of drift of the light rings 180, 182 from the center point 178. These variables also permit calibration of the non-interactive laser beam 33 using any of a number of calculational techniques.

As should apparent to those skilled in the art, the separations 170, 172, 174, 176 may be small gaps between individual ones of the photosensitive quadrants 162, 164, 166, 168.

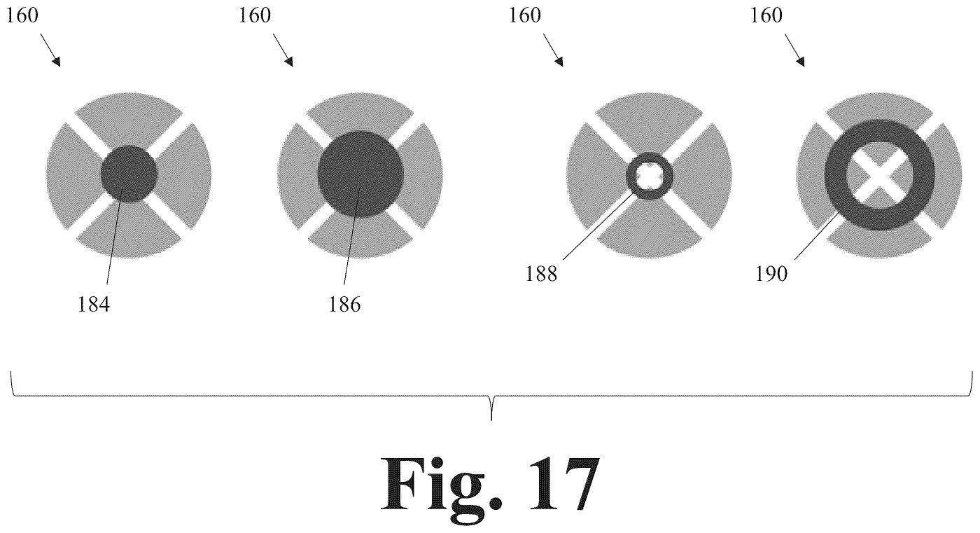

With reference to FIG. 17, aspects of the operation of the QUAD sensor 160 are now detailed.

Specifically, the four photosensitive quadrants 162, 164, 166, 168 may assist with calculating the amount of drift of the non-interactive laser spot 184, 186, 188, 190 from the center point 178 of the QUAD detector 160. As indicated by FIG. 17, for example, the four quadrants 162, 164, 166, 168 of the QUAD detector 160 help to measure the intensity and shape of the laser spots 184, 186, 188, 190. While not limiting of the present invention, for FIG. 17, a smaller laser spot (e.g., the laser spot 188) is indicative of a lower power of the non-interactive laser beam 33.

With renewed reference to FIGS. 10 and 11, it is noted that it may be necessary to adjust for the height location of the fiducial features 70, 78 depending on variables such as the thickness of the fiducial sheet 66 or the thickness of the recoater 82. This is because the fiducial features 70, 78 and/or photodiodes 104, 160 may be positioned small distances above the surface 32 of the print medium 20 deposited on the print bed 18.

In many instances, when a fiducial sheet 66 is employed, the fiducial sheet 66 is very thin. As a result, the location of the fiducial features 70 may be only 0.5 mm above the surface of the print medium 20. Here, the error at the edge of the fiducial features 70 is about 180 μm. As such, only a small correction factor, if any correction factor is employed, may be needed. In other constructions, larger correction factors may be required, as should be apparent to those skilled in the art.

Alternatively, when the fiducial features 70 are disposed a larger distance above the surface 32 of the print medium 20, it may become necessary to introduce a calculated correction to accommodate the displacement of the fiducial features 70 above the surface 32 of the print medium 20. In such a case, the correction factor may need to be adjusted as a function of the distance that the fiducial features 70 are disposed above the surface 32 of the print medium 20.

In one contemplated embodiment that uses the photodiodes 104, 160 to detect the laser spot (e.g., the laser spot 184, 186, 188, 190), it may be prudent to adjust for the positions of the photodiodes 104, 160, which are not in the same focal plane as the surface 32 of the print medium 20. Since the photodiodes 104, 160 are contemplated to be located in the recoater 72 (in one contemplated embodiment), the photodiodes 104, 160 are understood to the laser spot (e.g., the laser spot 184, 186, 188, 190) with an XY offset. The XY offset is understood to get larger as the distance increases between the location of the photodiodes 104, 160 and the surface 32 of the print medium 20. The XY offset may be corrected mathematically.

The present invention also provides for correction of the XY offset, taking into account the fact that the incidence angle of the non-interactive laser beam 33 to the photodiode 104, 160 changes as the distance between the photodiode 104, 160 and the surface 32 of the print medium 20 increases. Specifically, if the photodiode 104, 160 is 10 mm above the print medium 20, the offset error is up to 3.6 mm for a 20° incidence angle (edge of the scan field). This effect may be exaggerated at the corners.

The 3D printer 10, therefore, is understood to include a calibration methodology to resolve the height issue (i.e., the distance from the surface 32 of the print medium 20 to the photodiode(s) 104, 160).

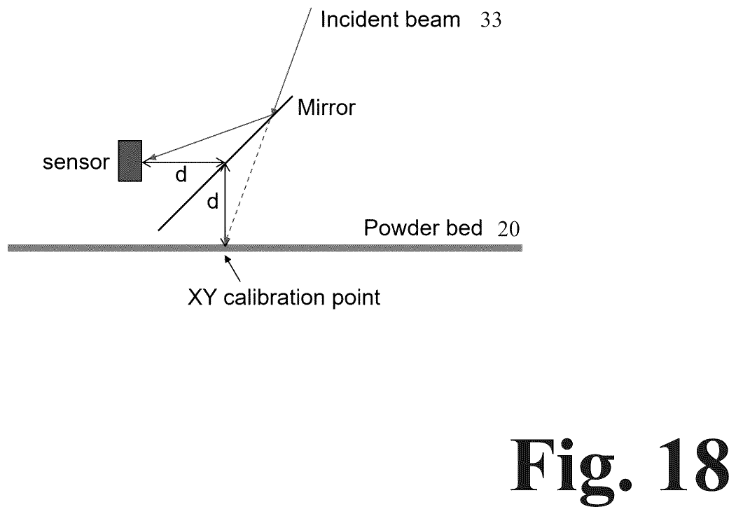

In one contemplated embodiment, the height issue may be addressed by incorporating a mirror to fold the non-interactive laser beam 33, thereby negating the height issue. This approach is illustrated in FIG. 18.

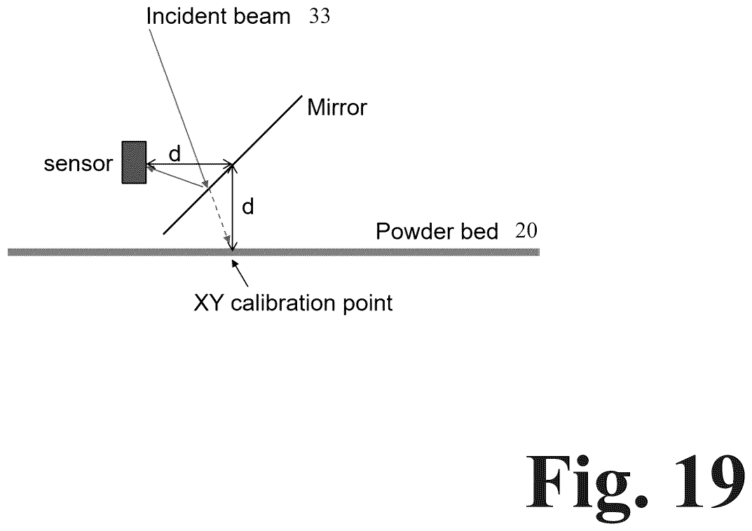

Still further, the height issue may be corrected using an algorithm that introduces a correction value that is dependent on the distance from the photodiode(s) to the surface 32 of the print medium 20, as shown, for example, in FIG. 19.

As should be apparent to those skilled in the art, other methodologies may be employed without departing from the scope of the present invention.

In the preceding discussion, the fiducial features 70 on the fiducial sheet 66, the fiducial features 78 on the surface 80 of the recoater 82, and the photodiodes 104 are discussed as being at the same locations each time that a calibration is performed. The present invention, however, is not limited solely to this configuration. It is contemplated, for other embodiments, that the locations of the fiducial features 70, 78 or the photodiodes 104 may change depending on the operational status of the 3D printer 10.

As should be apparent from the foregoing, the 3D printer 10 of the present invention encompasses elements of hardware and software. For example, the controller 26 is contemplated to include one or more processors, memory storage, and software components that are executable thereby. The term software is used herein in its commonly understood sense to refer to programs or routines (e.g., subroutines, objects, plug-ins, etc.), as well as data, usable by a machine or processor. As is well known, computer programs generally comprise instructions that are stored in machine-readable or computer-readable storage media. Some embodiments of the present invention may include executable programs or instructions that are stored in machine-readable or computer-readable storage media, such as a digital memory. This is not intended to convey or to imply that a “computer” in the conventional sense is required in any particular embodiment. For example, various processors, embedded or otherwise, may be used in equipment such as the components described herein.

Memory for storing software again is well known. In some embodiments, memory associated with a given processor may be stored in the same physical device as the processor (“on-board” memory); for example, RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc., such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such as a conventional rotating disk drive. All such memories are “machine readable” or “computer-readable” and may be used to store executable instructions for implementing the functions described herein.

A “software product” refers to a memory device in which a series of executable instructions are stored in a machine-readable form so that a suitable machine or processor, with appropriate access to the software product, can execute the instructions to carry out a process implemented by the instructions. Software products are sometimes used to distribute software. Any type of machine-readable memory, including without limitation those summarized above, may be used to make a software product. That said, it is also known that software can be distributed via electronic transmission (“download”), in which case there typically will be a corresponding software product at the transmitting end of the transmission, or the receiving end, or both.

In view of the many possible embodiments to which the principles of the disclosed technology may be applied, it should be recognized that the illustrated embodiments are only preferred examples and should not be taken as limiting the scope of the disclosure. We claim as our invention all that comes within the scope and spirit of the appended claims.

1. A 3D printer, comprising:
a print bed adapted to receive a layer of print medium thereon;
a recoater adapted to distribute the print medium onto the print bed to form the layer;
a laser source adapted to generate a non-interactive laser beam and an interactive laser beam, wherein the non-interactive laser beam does not alter the print medium, and wherein, when directed to at least one predetermined location on the layer, the interactive laser beam alters the print medium at the at least one predetermined location to form a portion of a printed component;
a controller connected to the laser source to direct the interactive laser beam to the at least one predetermined location;
a plurality of fiducial features associated with the recoater, wherein the plurality of fiducial features is presented by the recoater while the recoater distributes the print medium on the print bed to form the layer; and
a scanner connected to the controller to detect, via the non-interactive laser beam, the plurality of fiducial features and provide location information for locations of individual ones of the plurality of fiducial features;
wherein the controller compares the location information with predetermined position information for the individual ones of the plurality of fiducial features, calculates a deviation for each of the individual ones of the plurality of fiducial features, and performs a calibration to adjust where the interactive laser beam is directed to the print medium.

2. The 3D printer according to claim 1, wherein:
the plurality of fiducial features comprises a pattern of geometrical shapes.

3. The 3D printer according to claim 1, wherein:
the plurality of fiducial features comprises a grid pattern.

4. The 3D printer according to claim 1, wherein:
the print bed is adapted to receive a plurality of layers of the print medium, and the plurality of fiducial features comprises different patterns for different ones of the plurality of layers of the print medium.

5. The 3D printer according to claim 1, further comprising:
a fiducial sheet housing; and
a fiducial sheet connected, at a first end, to the recoater and, at a second end, to the fiducial sheet housing;
wherein the plurality of fiducial features is disposed on the fiducial sheet.

6. The 3D printer according to claim 5, wherein:
the fiducial sheet is flexible.

7. The 3D printer according to claim 6, wherein:
the fiducial sheet is retracted into the fiducial sheet housing.

8. The 3D printer according to claim 6, wherein:
the fiducial sheet is rolled up into the fiducial sheet housing.

9. The 3D printer according to claim 1, wherein:
the fiducial sheet is rigid.

10. The 3D printer according to claim 9, wherein:
the fiducial sheet is metal.

11. The 3D printer according to claim 9, wherein:
the fiducial sheet is glass.

12. The 3D printer according to claim 1, further comprising:
an encoder connected to the recoater,
wherein the recoater further comprises a recoater surface, and
wherein the plurality of fiducial features are disposed on the recoater surface.

13. The 3D printer according to claim 12, further comprising:
a stop switch connected to the encoder, wherein the stop switch ceases advancement of the recoater when the recoater reaches a predetermined position.

14. The 3D printer according to claim 1, further comprising:
an encoder connected to the recoater,
wherein the recoater further comprises a recoater blade, and
wherein the plurality of fiducial features is disposed on the recoater blade.

15. The 3D printer according to claim 14, further comprising:
a stop switch connected to the encoder, wherein the stop switch ceases advancement of the recoater when the recoater reaches a predetermined position.

16. A 3D printer, comprising:
a print bed adapted to receive a layer of print medium thereon;
a recoater adapted to distribute the print medium onto the print bed to form the layer;
a laser source adapted to generate a non-interactive laser beam and an interactive laser beam, wherein the non-interactive laser beam does not alter the print medium, and wherein, when directed to at least one predetermined location on the layer, the interactive laser beam alters the print medium at the at least one predetermined location to form a portion of a printed component;
a controller connected to the laser source to direct the interactive laser beam to the at least one predetermined location;
a plurality of photodiodes disposed on the recoater, wherein the plurality of photodiodes detects impingent positions of the noninteractive laser beam thereon at predetermined positions of the recoater;
wherein the controller compares the location information with the impingement positions, calculates a deviation for each of impingement positions, and performs a calibration to adjust where the interactive laser beam is directed to the print medium.

17. The 3D printer according to claim 16, wherein the plurality of photodiodes are QUAD detectors.

18. A 3D printer, comprising:
a print bed adapted to receive a layer of print medium thereon;
a recoater adapted to distribute the print medium onto the print bed to form the layer;
a laser source adapted to generate a laser beam, wherein, when directed to at least one predetermined location on the layer, the beam alters the print medium at the at least one predetermined location to form a portion of a printed component;
a controller connected to the laser source to direct the laser beam to the at least one predetermined location;
a plurality of photodiodes disposed on the recoater, wherein the plurality of photodiodes detects impingent positions of the laser beam thereon at predetermined positions of the recoater;
wherein the controller compares the location information with the impingement positions, calculates a deviation for each of impingement positions, and performs a calibration to adjust where the laser beam is directed to the print medium.

19. The 3D printer according to claim 18, wherein the plurality of photodiodes are QUAD detectors.
